(19) United States
(12) Patent Application Publication
(10) Pub. No.: US 2013/0342657 A1
(43) Pub. Date: Dec. 26, 2013

(54) STEREO VISION CAMERA FOR LASER RADAR

(71) Applicant: Nikon Corporation, Tokyo (JP)

(72) Inventor: Alec Robertson, Palo Alto, CA (US)

(73) Assignee: Nikon Corporation

(21) Appl. No.: 13/915,546

(22) Filed: Jun. 11, 2013

Related U.S. Application Data
(60) Provisional application No. 61/660,570, filed on Jun. 15, 2012.

(51) Int. Cl. H04N 13/02

(52) U.S. Cl. CPC H04N 13/0239
USPC 348/47

(57) ABSTRACT

Stereoscopic imaging systems are coupled to laser radar systems to permit selection of an intended scan area. Such imaging systems can also provide target depth data that can be used in conjunction with laser radar scan data. In some examples, stereoscopic images are presented to an inspector for operation assisted pointing of a laser radar axis or for computer-aided assessment of target conformance to design.

### CROSS REFERENCE TO RELATED APPLICATION

This application claims the benefit of U.S. Provisional Application 61/660,570, filed Jun. 15, 2012, which is incorporated herein by reference.

### FIELD

The disclosure pertains to laser radar and laser tracking systems.

### BACKGROUND

Laser radar systems provide simple, convenient non-contact measurements that aid single-operator object inspection. Laser radar systems are particularly useful for inspection applications in which large objects are to be measured such as in the manufacture and assessment of aircraft, automobile, wind turbine, satellite, and other oversized parts. Some conventional laser radar systems are described in U.S. Pat. Nos. 4,733,609; 4,824,251; 4,830,486; 4,969,736; 5,114,226; 7,139,446; 7,925,134; and Japanese Patent 2,664,399 which are incorporated herein by reference. In such laser radar systems, a laser beam is directed to and scanned over a target surface, and portions of the laser beam that are reflected or scattered back to the laser radar are detected and processed to provide target information.

In some cases, selecting an intended target area for laser radar measurement can be difficult. While a laser radar can provide a precise scan, laser radar scanning is generally not well suited to covering a large field of view or identifying a particular feature of interest among many target features.

### SUMMARY

Combining laser radar systems with cameras or other imaging systems can permit complementary depth measurement, stereoscopic imaging, and enhanced camera-based targeting of a laser radar. Parallax errors that can be introduced with a single camera and non-stereoscopic imaging can be reduced or eliminated with dual imaging systems that evaluate more than one target image obtained along differing axes. Such parallax errors can be especially difficult at short target distances.

In some examples, measurement apparatus comprise an imaging system configured to provide at least one image of a target area. An optical scanning system is coupled to the imaging system and configured to scan a target area portion based on a selected target area in the at least one image. In some embodiments, the imaging system is configured to provide at least two images associated with different imaging axes. In other examples, the imaging system includes a first camera configured to produce a first image associated with a first axis and a second camera associated with a second axis. In still further examples, an image processor is coupled to provide target distance based on the at least one image. According to some examples, the image processor is configured to provide a depth map of at least a portion of the target associated with the target area. In a representative example, the scanning system is a laser radar system that includes a first rotational stage and a second rotational stage configured to provide rotations of a scan axis of the laser radar system about orthogonal rotational axes, and the axes of the imaging system are configured to rotate with the scan axis.

In some examples, apparatus comprise an imaging system configured to provide at least two images of a target area, wherein the images are associated with different imaging axes. An optical scanning system is coupled to the imaging system and configured to scan a portion of the target area. In some examples, the optical scanning system is configured to scan the portion of the target area based on the at least two images. In additional examples, the imaging system includes a first camera configured to produce a first image associated with a first axis and a second camera associated with a second axis. According to some embodiments, an image processor is coupled to provide a target distance based on the at least two images or to provide a depth map of at least a portion of the target associated with the target area based on the at least two images. In representative embodiments, the optical scanning system includes at least one laser coupled to direct an optical beam to a target and an optical detection system configured to receive a portion of the optical beam from the target and to establish an estimate of a target distance based on the received portion. The optical scanning system is configured to scan the optical beam over the target area and establish distance estimates associated with a plurality of locations in the target area. In some examples, the imaging axes are parallel axes, and the optical scanning system is configured to scan a laser beam over a target along a scan axis that is parallel to the imaging axes. In representative embodiments, the scan axis is equidistant from the imaging axes and the scan axis and the imaging axes are coplanar. Typically, the optical scanning system includes a beam steering system configured to rotate the scan axis and the imaging axes in an azimuthal direction about an azimuthal axis and in an elevational direction about an elevational axis. In some embodiments, the imaging axes and the scan axis intersect the azimuthal axis or the elevational axis. In still other examples, the first and second cameras are secured to the beam steering assembly. The optical scanning system can be a laser radar system or a laser tracking system.

Methods comprise obtaining a stereoscopic image of a target area and directing an interrogation optical beam of an optical scanning system to the target area. In some examples, a portion of the target area to be scanned is selected based on the stereoscopic image. In typical examples, stereoscopic images of the target are obtained as the interrogation beam is directed to the target. In some examples, the stereoscopic image based on a first image and a second image that are associated with different imaging axes. According to some embodiments, the interrogation beam is directed along a scan axis, and the scan axis and the imaging axes are parallel. In further examples, the interrogation beam is scanned by rotating the scan axis an azimuthal direction about an azimuthal axis and in an elevational direction about an elevational axis. In some examples, the imaging axes and the scan axis intersect the azimuthal axis or the elevational axis. In some alternatives, the stereoscopic image is based on first second images obtained with first and second cameras, respectively. In typical examples, the first and second cameras are secured to a beam steering assembly configured to rotate the scan axis.

Inspection systems comprise a stereoscopic camera system configured to provide an image of a target and a controller configured to select a scan area based on the image. An optical beam scanning system is configured to scan an optical beam in the selected scan area and a detection system is configured to provide target dimensions for a plurality of target surface locations. In some examples, the beam scanning system is configured to scan imaging axes associated with the stereoscopic image and a scan axis of the optical beam scanning system. According to some examples, the imaging axes and the scan axis are parallel and coplanar, and the beam scanning system is configured to provide elevational and azimuthal scanning. In some alternatives, a target surface evaluator is configured to indicate deviations of the target surface from a reference target surface that is defined by a target surface design. In some embodiments, the indicated deviation is provided based on a determination of whether the target surface corresponds to the target surface design with a design tolerance.

The foregoing and other objects, features, and advantages of the disclosure will become more apparent from the following detailed description, which proceeds with reference to the accompanying figures.

### BRIEF DESCRIPTION OF THE DRAWINGS

FIG. 1 is a perspective view of a laser rangefinder that includes a stereoscopic camera system.

FIG. 2 is a schematic diagram of a laser rangefinder that includes a stereoscopic camera system.

FIG. 3 is a schematic diagram of a laser rangefinder that includes a stereoscopic camera system with a single image sensor.

FIG. 4 is a schematic diagram of a laser rangefinder that includes a stereoscopic camera system with cameras directed along intersecting axes.

FIG. 5 is a perspective view of an alternative laser rangefinder that includes a stereoscopic camera system.

FIG. 6 is a block diagram of a representative inspection system that includes a stereoscopic camera and an optical beam scanner.

FIG. 7 is a block diagram of a representative method inspecting a surface.

FIG. 8 is a block diagram of a representative method of tracking a tooling ball that is secured to a substrate or target.

FIG. 9 is a block diagram of a representative manufacturing system that includes a laser radar or other profile measurement system to manufacture components, and assess whether manufactured parts are defective or acceptable.

FIG. 10 is a block diagram illustrating a representative manufacturing method that includes profile measurement to determine whether manufactured structures or components are acceptable, and if one or more such manufactured structures can be repaired.

### DETAILED DESCRIPTION

As used in this application and in the claims, the singular forms “a,” “an,” and “the” include the plural forms unless the context clearly dictates otherwise.

Additionally, the term “includes” means “comprises.” Further, the term “coupled” does not exclude the presence of intermediate elements between the coupled items.

The systems, apparatus, and methods described herein should not be construed as limiting in any way. Instead, the present disclosure is directed toward all novel and non-obvious features and aspects of the various disclosed embodiments, alone and in various combinations and sub-combinations with one another. The disclosed systems, methods, and apparatus are not limited to any specific aspect or feature or combinations thereof, nor do the disclosed systems, methods, and apparatus require that any one or more specific advantages be present or problems be solved. Any theories of operation are to facilitate explanation, but the disclosed systems, methods, and apparatus are not limited to such theories of operation.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatus can be used in conjunction with other systems, methods, and apparatus. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art.

For convenience, beams are described as propagating along one or more axes. Such axes generally are based on one or more line segments so that an axis can include a number of non-collinear segments as the axis is bent or folded or otherwise responsive to mirrors, prisms, lenses, and other optical elements. The term “lens” is used herein to refer to a single refractive optical element (a singlet) or a compound lens that includes one or more singlets, doublets, or other elements. In some examples, beams are shaped or directed by refractive optical elements, but in other examples, reflective optical elements such as minors are used, or combinations of refractive and reflective elements are used. Such optical systems can be referred to as dioptric, catoptric, and catadioptric, respectively. Other types of refractive, reflective, diffractive, holographic and other optical elements can be used as may be convenient.

In the disclosed examples, methods and apparatus provide scanning of an optical beam such as a laser beam over a target. In some cases, scanning is used to establish distances to a target surface so as to provide a target depth profile. In other examples, laser beams or other optical beams are scanned so as to track or to locate a target or a particular target feature. As used herein, optical scanning systems include laser rangefinders, trackers, target finders, and other systems that inspect, identify, or interrogate a target by scanning an optical beam over the target. In some examples, cameras or other imaging system provide viewable images or image data that can be stored in physical storage devices such as RAM, ROM, hard disks, or other hardware. Viewable images and image data are both referred to herein as images.

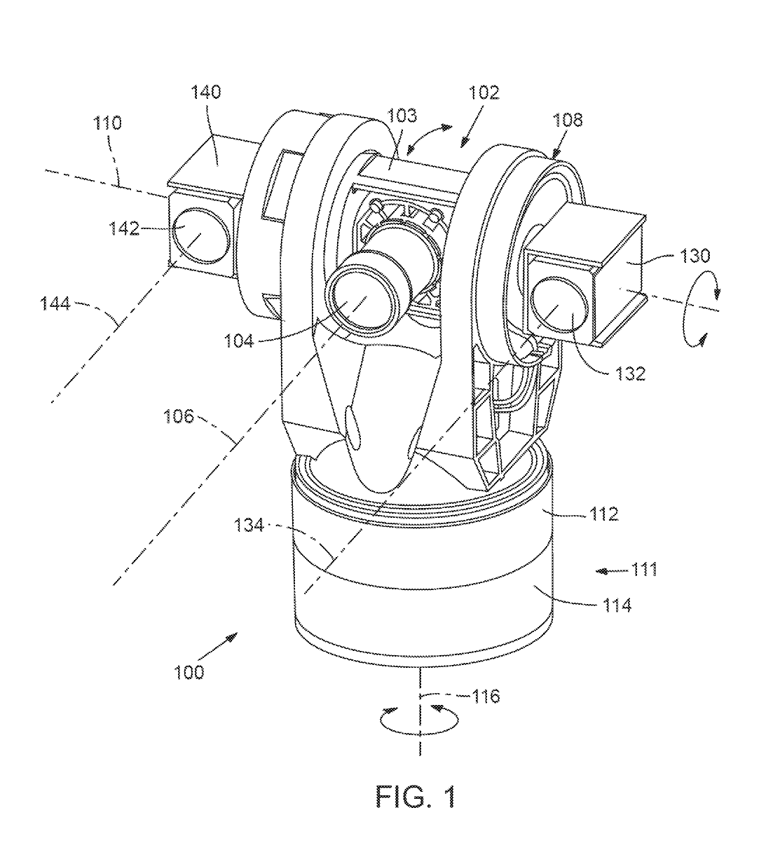

FIG. 1 is a perspective view of a laser rangefinder 100 that includes a laser radar 102 secured to an elevation rotational stage 108 that is configured to rotate about an elevation axis 110. The elevation stage 108 is secured to an azimuthal rotational stage 111 that is configured to rotate about an azimuthal axis 116. The axes 110, 116 are generally intersecting orthogonal axes, and are described herein as azimuthal and elevation axes for convenience, as such axes may be arranged so as to be in arbitrary directions. For convenient illustration, control systems used for adjustment of rotation angles are not shown in FIG. 1.

The laser radar 102 includes optical and electrical systems configured to deliver an interrogation beam to a target from an aperture 104 along a laser radar axis 106. The laser radar typically 102 includes a housing 103 that is secured to the elevation stage 108 so that the laser radar axis 106 can be scanned over the target with the elevation stage 108 and the azimuth stage 111. Some portions of the laser radar 102 can be provided separately from the housing 103, and are not rotatable. For example, control electronics, fiber coupled lasers and/or detectors and associated transmitter and detector electronics, and signal processing can be located remotely. Typically, a housed portion of the laser radar 102 includes transmit and receive optical systems. The azimuthal stage 111 includes a rotatable platform 112 to which the elevation stage 108 is secured and a fixed platform 114. Rotation of the rotatable platform 112 about the axis 116 permits scanning of the laser radar axis 104 over a target.

The laser rangefinder 100 also includes a first camera 130 and a second camera 140 that are secured so as to rotate with the laser radar housing 103. The cameras 130, 140 are configured to image through apertures 132, 142 along imaging axes 134, 144, respectively, and provide images of at least some portions of a target or of areas situated about the laser radar axis 104. In typical examples, the camera axes 134, 144 are substantially parallel to the laser radar axis and are orthogonal to and intersect the elevation axis 110. However, other arrangements can be used, as may be convenient. For example, the camera axes 134, 144 can be arranged to be intersecting or divergent.

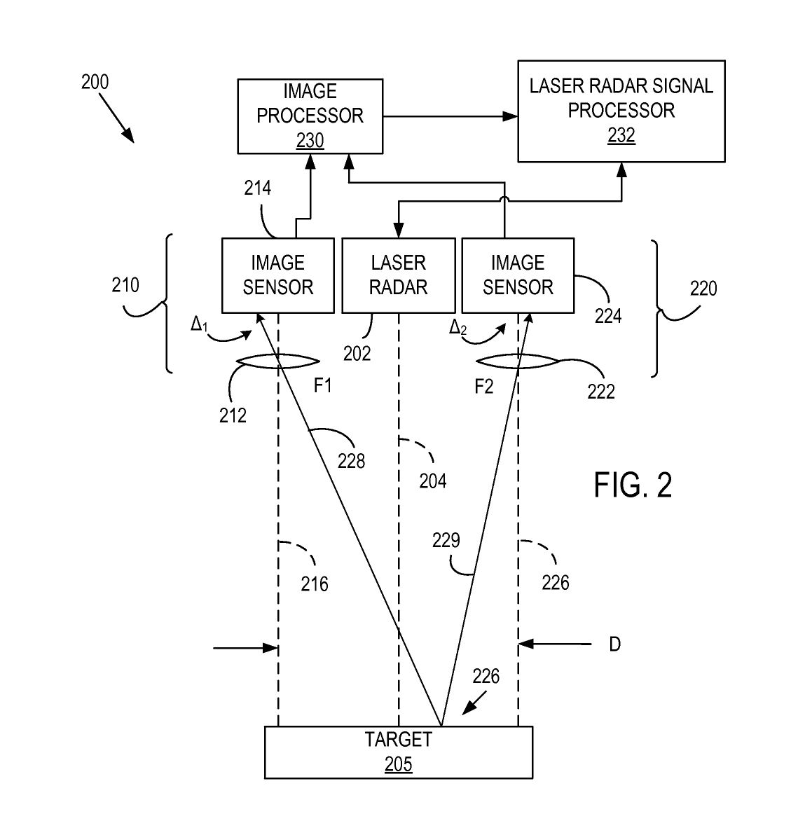

FIG. 2 illustrates a representative laser rangefinder 200 that includes a laser radar 202 situated to have a scan axis 204 that is directed to a target 205. First and second cameras 210, 220 include lenses 212, 222 that are configured to form images at image sensors 214, 224, respectively. As shown in FIG. 2, the first and second cameras have associated axes 216, 226 that are parallel to the scan axis 206.

In the arrangement shown in FIG. 2, a target region 230 that is offset from the scan axis 204 is associated with image locations at the image sensors 214, 224 that are offset from the camera axes 216, 226 by distances Δ₁, Δ₂, respectively, as shown by image plane locations of principal rays 228, 229. In FIG. 2, the camera axes 216, 226 are equidistant from the scan axis 204 so that an on-scan axis portion of the target is associated with Δ₁=-Δ₂. For other camera axis displacements and axis directions, other differences Δ₁, Δ₂ can be associated with on-scan axis positions. Such positions can be estimated based on a separation D of the camera axes 216, 226 and focal lengths F1, F2 of the lenses 212, 222, although as shown in FIG. 2, F1=F2. In some examples, image distances D_{I1}, D_{I2} between the lenses 212, 22 and respective image sensors 214, 224 can be used. Typically, the camera axes 216, 226 are fixed with respect to the scan axis 204 and are scanned along with the scan axis 204.

An image processor 230 is coupled to receive image data from the image sensors 214, 224 and determine image characteristics such as displacements from the scan axis 204. A laser radar controller 232 processes laser radar data and controls the laser radar 202 to scan the target 205 and provide range estimates.

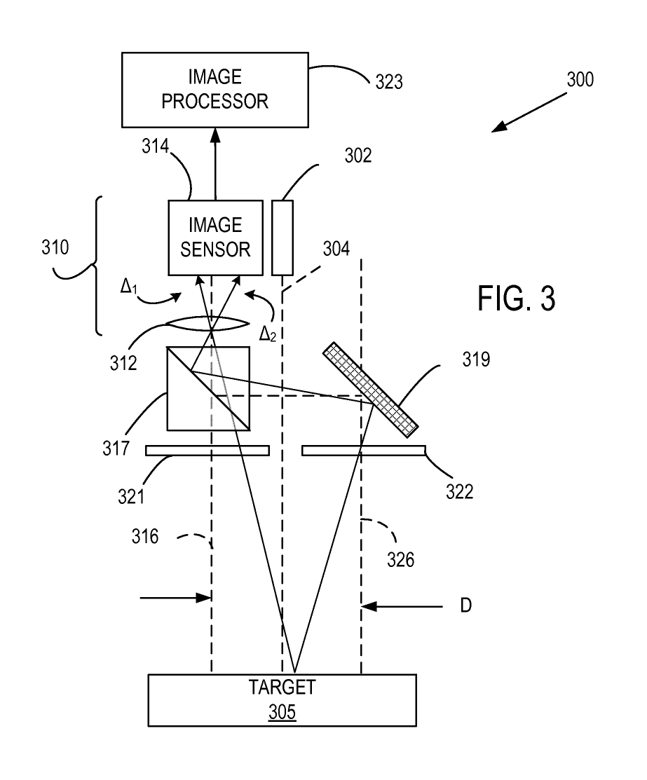

A rangefinder system 300 as shown in FIG. 3 includes a single camera 310 with an image sensor 314 and lens 312. A beam splitter 317 is situated along a camera axis 316 so as to produce a virtual camera axis 326 in conjunction with a reflector 319. Shutters 321, 322 can be controlled to permit acquisition of an image associated with a selected one of the axes 316, 326. The image sensor 314 and an associated image processing system 323 can be used to estimate target location or provide a stereoscopic target image. In some examples, displacements Δ₁, Δ₂ are determined. A laser radar system 302 is situated to direct a laser beam along a scan axis 304 to a target 305.

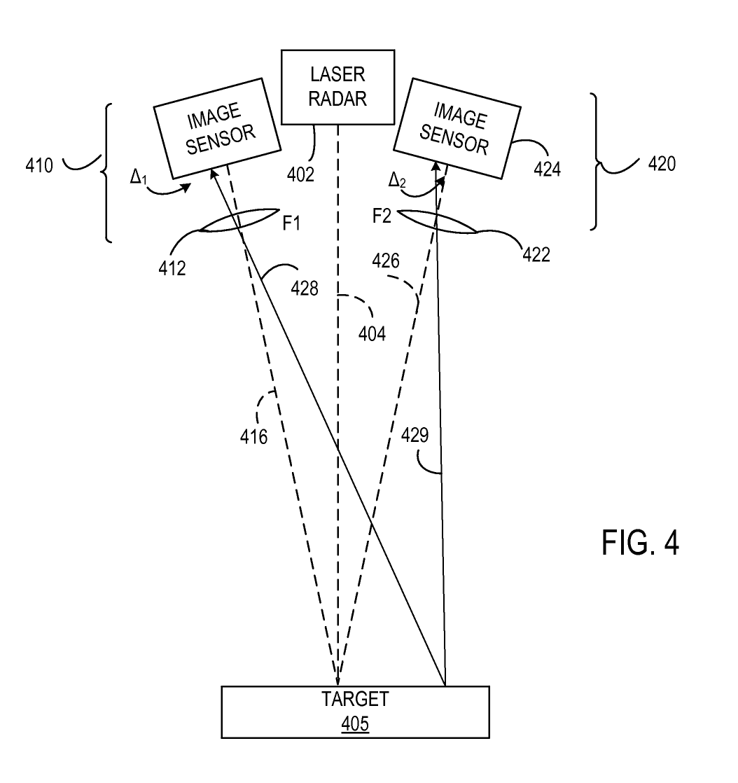

A rangefinder system as illustrated in FIG. 4 includes cameras 410, 420 that have respective lenses 412, 422 and image sensors 414, 424 that are situated along respective camera axes 416, 426 that are directed toward an intersection with an axis 404 of a laser radar system 402. Principal rays 428, 429 from an off-axis portion of a target 405 are associated with image displacements Δ₁, Δ₂ that can serve to provide a distance estimate, or the images can be used to form a stereoscopic image.

Imaging systems as described above can be configured to provide depth estimates in addition to laser radar range measurements, to be used in targeting a laser radar to particular features of interest, or to provide a three dimensional map of a target and a target environment.

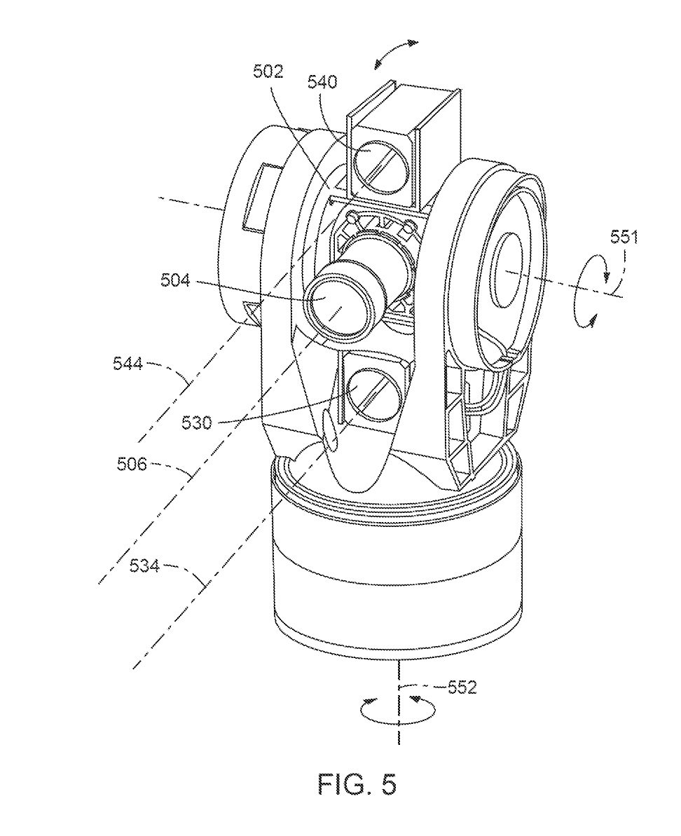

In other examples, cameras and imaging axes can be situated at other locations with respect to a laser radar. For example, as shown in FIG. 5, a rangefinder system includes a laser radar 502 having a beam aperture 504 that directs an interrogation optical beam along an axis 506. The rangefinder includes rotational stages so that the laser radar 502 can be rotated about axes 551, 552 for scanning. Cameras 530, 540 are fixed with respect to the laser radar 502 and produce target images with respect to respective camera axes 534, 544.

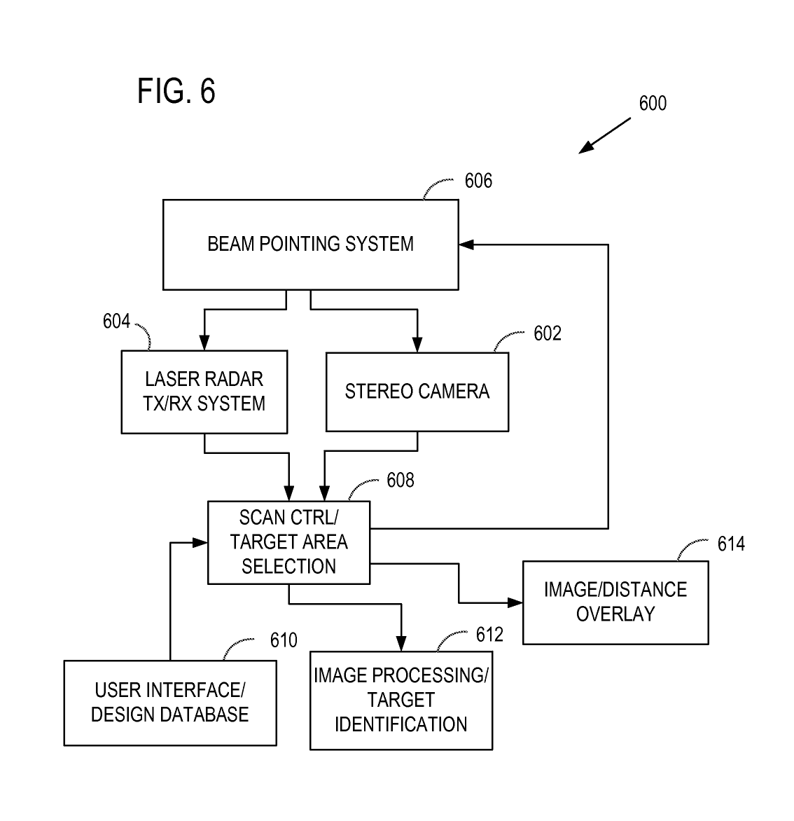

With reference to FIG. 6, a representative inspection system 600 includes a laser radar receiver/transmitter system 604 and a stereo camera system 602 that are coupled to a beam pointing system 606 that is generally configured so that a laser radar optical beam scans a target area. A controller 608 is coupled to the laser radar system 604 and the stereo camera 602 and identifies a target area to be scanned based on a stereoscopic image. The controller 608 directs the beam pointing system so as to scan the laser radar beam on the target to obtain target information. The controller 608 is also coupled to a design data base 610 and can compare laser radar derived target data with design data (and design tolerances) to determine if a scanned surface is acceptable based on design and design tolerances. The controller 608 is also includes a process module 612 configured to process one or more stereoscopic images to identity target locations. The module 612 can be implemented in hardware, software, firmware, or combinations thereof. If desired, the controller can generate visible images and provide images to a display 614, and overlay or juxtapose measured and design information as desired.

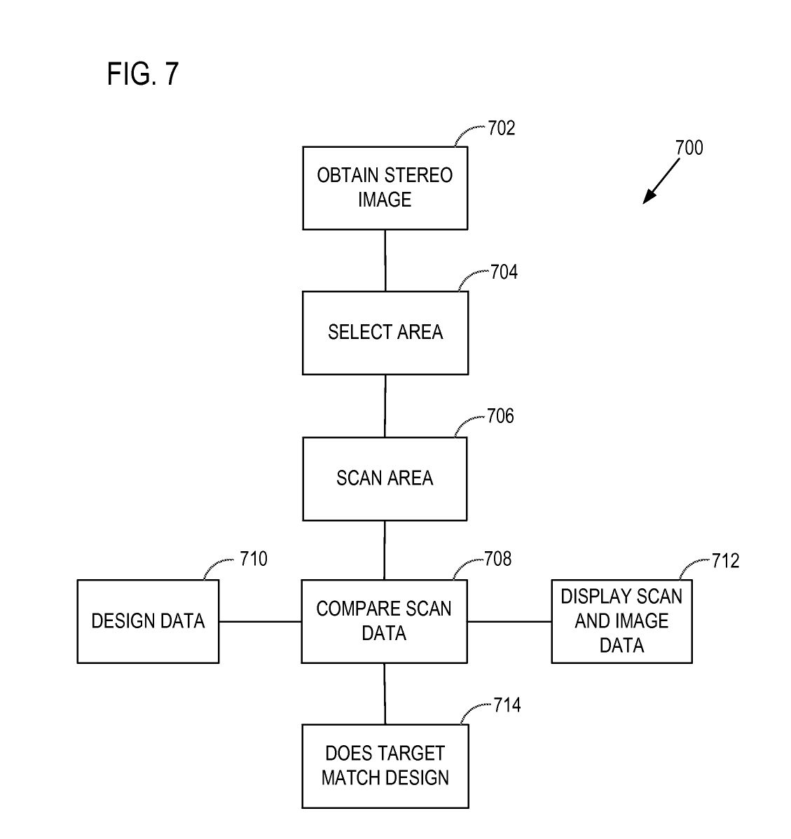

Referring to FIG. 7, a representative inspection method 700 includes obtaining a stereoscopic image of a target surface at 702 and selecting an area for scanning at 704. The area is scanned at 706 to obtain surface depth data based on a laser radar or other scan procedure, and the surface depth data is compared with design data from a database 710 at 708. Images and scan results can be displayed for user viewing at 712. At 714, a determination as to whether the scanned target area meets design specifications (within a tolerance) is made and communicated to a user. In other examples, the area scanned so that a target feature can be tracked, and depth data is not provided.

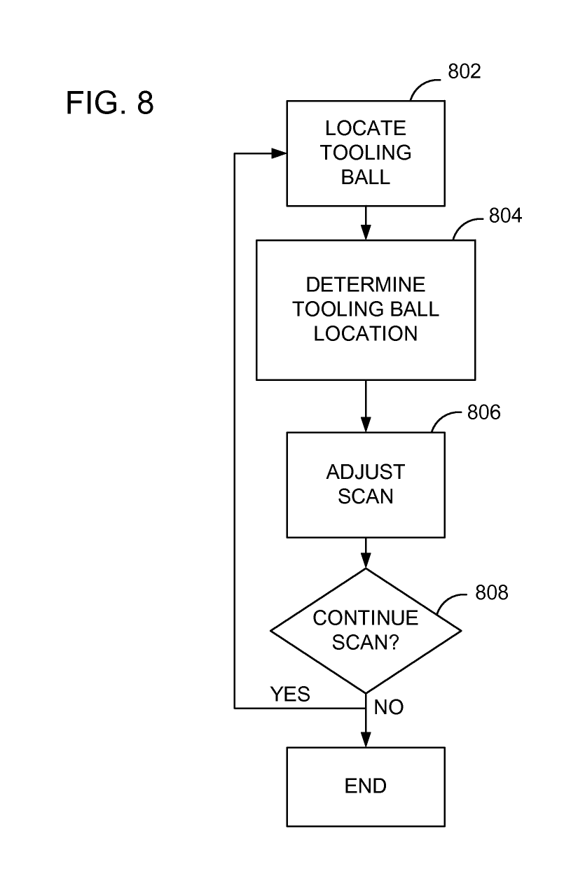

FIG. 8 illustrates a representative method of tracking a tooling ball that is secured to a substrate or target. One or more tooling balls can be secured to a target to provide reference points for coordinate determinations. Tooling balls generally include a reflective ball-shaped surface in order to provide ample reflection of an interrogation beam in a laser-based measurement apparatus such as a laser radar.

As shown in FIG. 8, at 802 a tooling ball location is identified and recorded based on returned portions of a scanned interrogation optical beam or using one or more camera systems as shown above. The optical beam can be scanned in a variety of patterns such as circles, spirals, w's, or zig-zags so as to track a tooling ball. At 804, the identified location is evaluated to determine a position with respect to a scan. The scan is adjusted at 806 so that the tooling ball location is at a preferred location with respect to the primary scan. Typically, the primary scan is adjusted so that the tooling location is approximately centered within a primary scan range. At 808, a determination is made regarding additional scanning.

In embodiments described above, inspection methods are based on obtaining a stereoscopic image of a target surface with a stereoscopic camera system, and scanning and adjusting a tooling location. However, other inspection methods are possible. For example, a region of interest in a target can be identified and inspected using a stereoscopic camera. Based on data acquired with the stereoscopic camera, a laser radar system can measure a region of interest without scanning. When a “B” position in a target is a location of interest, an interrogation beam can be directed to the “B” position based on data from a stereoscopic camera.

Stereoscopic camera data can also be used to calibrate a laser radar system. For example, a depth difference between depths at target locations “B” and “C” can be calculated based on data from the stereoscopic camera. A lateral position difference between locations “B” and “C” can also be obtained. Comparison of such lateral and depth differences obtained using a stereoscopic camera permits calibration of laser radar measurements. If stereoscopic camera and laser radar measurement data are sufficiently different, one or both of the stereoscopic camera and the laser radar can be calibrated. For example, a laser elevational stage or azimuthal stage or a laser pointing direction can be calibrated so that stereoscopic camera and scan-based measurements agree.

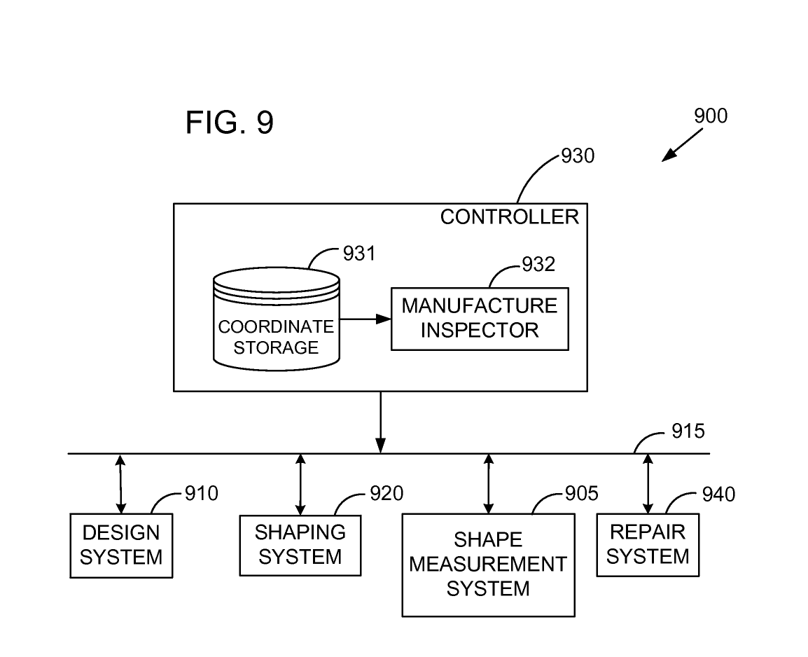

FIG. 9 illustrates a representative manufacturing system 900 suitable for producing one or more components of a ship, airplane, or part of other systems or apparatus, and for evaluating and reprocessing such manufactured components. The system 900 typically includes a shape or profile measurement system 905 such as the laser radars and rangefinders discussed above. The manufacturing system 900 also includes a design system 910, a shaping system 920, a controller 930, and a repair system 940. The controller 930 includes coordinate storage 931 configured to store measured and design coordinates or other characteristics of one or more manufactured structures as designed and/or measured. The coordinate storage 931 is generally a computer readable medium such as hard disk, random access memory, or other memory device. Typically, the design system 910, the shaping system 920, the shape measurement system 905, and a repair system 940 communicate via a communication bus 915 using a network protocol.

The design system 910 is configured to create design information corresponding to shape, coordinates, dimensions, or other features of a structure to be manufactured, and to communicate the created design information to the shaping system 920. In addition, the design system 910 can communicate design information to the coordinate storage 931 of the controller 930 for storage. Design information typically includes information indicating the coordinates of some or all features of a structure to be produced.

The shaping system 920 is configured to produce a structure based on the design information provided by the design system 910. The shaping processes provided by the shaping system 920 can include casting, forging, cutting, or other process. The shape measurement system 905 is configured to measure the coordinates of one or more features of the manufactured structure and communicate the information indicating measured coordinates or other information related to structure shape to the controller 930.

A manufacture inspector 932 of the controller 930 is configured to obtain design information from the coordinate storage 931, and compare information such as coordinates or other shape information received from the profile measuring apparatus 100 with design information read out from the coordinate storage 931. The manufacture inspector 932 is generally provided as a processor and a series of computer-executable instructions that are stored in a tangible computer readable medium such as random access memory, a flash drive, a hard disk, or other physical devices. Based on the comparison of design and actual structure data, the manufacture inspector 932 can determine whether or not the manufacture structure is shaped in accordance with the design information, generally based on one or more design tolerances that can also be stored in the coordinate storage 931. In other words, the manufacture inspector 932 can determine whether or not the manufactured structure is defective or non-defective. When the structure is not shaped in accordance with the design information (and is defective), then the manufacture inspector 932 determines whether or not the structure is repairable. If repairable, then the manufacture inspector 932 can identify defective portions of the manufactured structure, and provide suitable coordinates or other repair data. The manufacture inspector 932 is configured to produce one or more repair instructions or repair data and forward repair instructions and repair data to the repair system 940. Such repair data can include locations requiring repair, the extent of re-shaping required, or other repair data. The repair system 940 is configured to process defective portions of the manufactured structure based on the repair data.

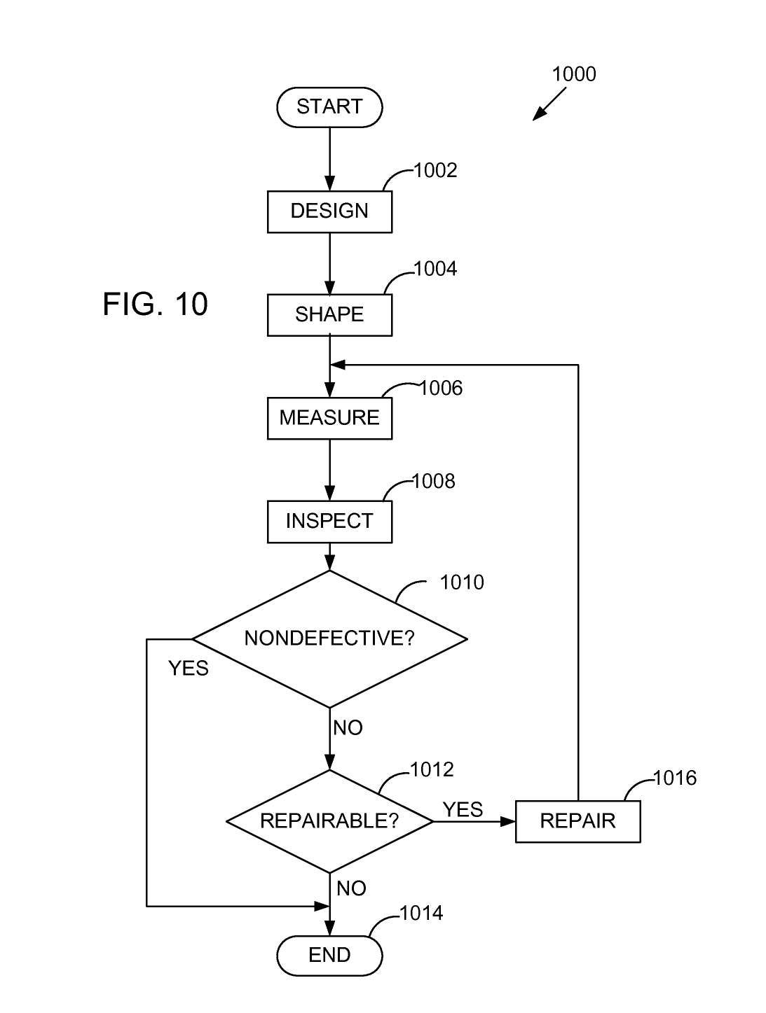

FIG. 10 is a flowchart showing a representative manufacture method 1000 that can incorporate manufacturing systems such as illustrated in FIG. 9. At 1002, design information is obtained or created corresponding to a shape of a structure to be manufactured. At 1004, the structure is manufactured or “shaped” based on the design information. At 1006, coordinates, dimensions, or other features of the manufactured structure are measured with a profile measurement system such as the laser radar systems described above to obtain shape information corresponding to the structure as manufactured. At 1008, the manufactured structure is inspected based on a comparison of actual and design dimensions, coordinates, manufacturing tolerance, or other structure parameters. At 1010, if the manufactured structure is determined to be non-defective, the manufactured part is accepted and processing ends at 1014. If the manufacture part is determined to be defective at 1010 by, for example, the manufacture inspector 932 of the controller 930 as shown in FIG. 9, then at 1012 it can be determined whether the manufacture part is repairable. If repairable, the manufactured part is reprocess or repaired at 1016, and then measured, inspected, and reevaluated at 1006, 1008, 1010, respectively. If the manufactured part is determined to be unrepairable at 1012, the process ends at 1014.

According to the method of FIG. 10, using a profile measurement system to accurately measure or assess coordinates or other features of a manufactured structure, a manufactured structure can be evaluated to determine if the structure is defective or non-defective. Further, if a manufactured structure is determined to be defective, reprocessing can be initiated if the part is deemed to be repairable based on design and actual structure dimensions and features. By repeating the measurement, inspection, and evaluation processes, defective parts can be reprocessed, and parts that are defective but that are not repairable can be discarded. The particular systems and methods of FIGS. 9-10 are exemplary only, and other arrangements can be used.

In the above embodiment, the structure manufacturing system 900 can include a profile measuring system such as the laser radars and rangefinders described above, the design system 910, the shaping system 920, the controller 930 that is configured to determine whether or not a part is acceptable (inspection apparatus), and the repair system 940. However, other systems and methods can be used and examples of FIGS. 9-10 are provided for convenient illustration.

The above examples are provided for convenient illustration, and should not be taken as limiting the scope of the disclosure. We claim all that is encompassed by the appended claims.

We claim:

1. An apparatus, comprising:
an imaging system configured to provide at least two images of a target area, wherein the images are associated with different imaging axes; and
an optical scanning system coupled to the imaging system and configured to scan a portion of the target area.

2. The apparatus of claim 1, wherein the optical scanning system is configured scan the portion of the target area based on the at least two images.

3. The apparatus of claim 2, wherein the imaging system includes a first camera configured to produce a first image associated with a first axis and a second camera configured to produce a second image associated with a second axis.

4. The apparatus of claim 1, further comprising an image processor coupled to provide a target distance based on the at least two images.

5. The apparatus of claim 4, wherein the image processor is configured to provide a depth map of at least a portion of the target associated with the target area based on the at least two images.

6. The apparatus of claim 1, wherein the optical scanning system includes at least one laser coupled to direct an optical beam to a target and an optical detection system configured to receive a portion of the optical beam from the target and establish an estimate of a target distance based on the received portion.

7. The apparatus of claim 6, wherein the laser is coupled so as to direct a focused optical beam to the target.

8. The apparatus of claim 7, wherein the optical scanning system is configured to scan the optical beam over the target area and establish distance estimates associated with a plurality of locations in the target area.

9. The apparatus of claim 1, wherein the imaging axes are parallel axes.

10. The apparatus of claim 9, wherein the optical scanning system is configured to scan a laser beam over a target along a scan axis, wherein the scan axis is parallel to the imaging axes.

11. The apparatus of claim 10, wherein the scan axis is equidistant from the imaging axes.

12. The apparatus of claim 11, wherein the scan axis and the imaging axes are coplanar.

13. The apparatus of claim 12, wherein the optical scanning system includes a beam steering system configured to rotate the scan axis and the imaging axes in an azimuthal direction about an azimuthal axis and in an elevational direction about an elevational axis.

14. The apparatus of claim 13, wherein the imaging axes and the scan axis intersect the azimuthal axis.

15. The apparatus of claim 13, wherein the imaging axes and the scan axis intersect the elevational axis.

16. The apparatus of claim 13, wherein the first and second cameras are secured to the beam steering assembly.

17. The apparatus of claim 1, wherein the optical scanning system is a laser radar system or a laser tracking system.

18. A method, comprising:
obtaining a stereoscopic image of a target area; and
directing an interrogation optical beam of an optical scanning system to the target area.

19. The method of claim 18, further comprising selecting a portion of the target area to be scanned based on the stereoscopic image.

20. The method of claim 18, further comprising obtaining stereoscopic images of the target as the interrogation beam is directed to the target.

21. The method of claim 18, further comprising obtaining the stereoscopic image based on a first image and a second image that are associated with different imaging axes.

22. The method of claim 21, wherein the interrogation beam is directed along a scan axis, and the scan axis and the imaging axes are parallel.

23. The method of claim 22, further comprising scanning the interrogation beam by rotating the scan axis an azimuthal direction about an azimuthal axis and in an elevational direction about an elevational axis.

24. The method of claim 23, wherein the imaging axes and the scan axis intersect the azimuthal axis.

25. The method of claim 23, wherein the imaging axes and the scan axis intersect the elevational axis.

26. The method of claim 23, wherein the stereoscopic image is based on first second images obtained with first and second cameras, respectively.

27. The method of claim 26, wherein the first and second cameras are secured to a beam steering assembly configured to rotate the scan axis.

28. An inspection system, comprising:
a stereoscopic camera system configured to provide at least two images of a target;
a controller configured to select a scan area based on the images;
an optical beam scanning system configured to scan an optical beam in the selected scan area; and
a detection system configured to provide target dimensions for a plurality of target surface locations.

29. The inspection system of claim 28, wherein the beam scanning system is configured to scan imaging axes associated with the stereoscopic image and a scan axis of the optical beam scanning system.

30. The inspection system of claim 28, wherein the imaging axes and the scan axis are parallel and coplanar, and the beam scanning system is configured to provide elevational and azimuthal scanning.

31. The inspection system of claim 30, further comprising a target surface evaluator configured to indicate deviations of the target surface from a reference target surface.

32. The inspection system of claim 31, wherein the reference target surface is a defined by a target surface design.

33. The inspection system of claim 32, wherein the indicated deviation is provided based on a determination if the target surface corresponds to the target surface design.
